(19) United States
(12) Patent Application Publication
(10) Pub. No.: US 2022/0120904 A1
(43) Pub. Date: Apr. 21, 2022

(54) IMAGING LIDAR

(71) Applicant: Michigan Aerospace Corporation, Ann Arbor, MI (US)

(72) Inventor: Will JOHNSON, Saline, MI (US)

(21) Appl. No.: 17/424,092

(22) PCT Filed: Jan. 21, 2020
(86) PCT No.: PCT/US2020/014403

§ 371 Date: Jul. 19, 2021

Related U.S. Application Data
(60) Provisional application No. 62/794,834, filed on Jan. 21, 2019.

(51) Int. Cl. G01S 17/36; G01S 7/4915; G01S 7/481

(52) U.S. Cl. CPC G01S 17/36; G01S 17/89; G01S 7/4811; G01S 7/4915

(57) ABSTRACT

The distance to multiple points in a scene are measured in accordance with a system and method employing, in some embodiments, a plurality of emitters arranged to emit electromagnetic waves toward a scene substantially simultaneously, a receiver arranged to receive the electromagnetic waves after being scattered from multiple points in the scene, and to output a signal corresponding to each received electromagnetic wave, and computing electronics configured to compare a phase of the emitted electromagnetic waves with a phase of each corresponding received electromagnetic wave in the output signal and determine a distance to each of the multiple points based on the comparison of the phases. Each of the plurality of emitters may be intensity modulated at a different respective frequency, permitting identification of the emitter corresponding to each of the isolated frequencies.

### CROSS REFERENCE TO RELATED APPLICATIONS

This application is a national stage application filed under 35 U.S.C. § 371, of International Patent Application No. PCT/US2020/014403, filed on Jan. 21, 2020, which claims priority to U.S. Provisional Application No. 62/794,834, filed on Jan. 21, 2019, both of which are hereby incorporated by reference in their entireties.

### BACKGROUND OF THE INVENTION

A system and method of making simultaneous, or substantially simultaneous, distance measurements to multiple points in a scene are described below.

In some time of flight LIDAR (Light Detection And Ranging) systems, a pulse of laser energy is sent toward a target and the distance to the target is calculated based on the time delay between when the laser pulse is emitted and when the signal is received (with the speed of light known). To sample multiple points in a scene, the laser transmitter (emitter) and receiver (detector) are directed to “look” in different directions with the aid of one or more mirrors or prisms using moving parts that can fail mechanically. The mirrors or prisms essentially scan a single pixel LIDAR across the scene and generate a two-dimensional image of distance to targets in the scene.

In some flash LIDAR systems, a single laser pulse is emitted at a wide angle to flood the scene with the laser pulse, and an array of time-of-flight detectors independently measure the time for the laser pulse to arrive at a point in the scene corresponding to the detector. This method is attractive in that no moving parts are required, but suffers from the cost and complexity required to make a multi-element time-of-flight camera detector array.

### SUMMARY OF THE INVENTION

As more fully described below, and in accordance with at least one embodiment, a system for determining the distance to multiple points in a scene may comprises a plurality of emitters arranged to emit electromagnetic waves toward a scene substantially simultaneously; a receiver arranged to receive the electromagnetic waves after being scattered from multiple points in the scene, and to output a signal corresponding to each received electromagnetic wave; and computing electronics configured to compare a phase of the emitted electromagnetic waves with a phase of each corresponding received electromagnetic wave in the output signal and determine a distance to each of the multiple points based on the comparison of the phases.

In accordance with at least one embodiment, a method for measuring multiple distances with a plurality of emitters and a single photodetector may comprising emitting electromagnetic waves toward a scene substantially simultaneously; receiving the electromagnetic waves after being scattered from multiple points in the scene; outputting a signal corresponding to each received electromagnetic wave; comparing a phase of the emitted electromagnetic waves with a phase of each corresponding received electromagnetic wave in the output signal; and determining a distance to each of the multiple points based on the comparison of the phases.

### BRIEF DESCRIPTION OF THE DRAWINGS

FIG. 1 illustrates an example of calculating a distance to a target in accordance with one or more embodiments described herein.

FIG. 2A illustrates an example of an optical arrangement in accordance with one or more embodiments described herein.

FIG. 2B illustrates power modulation of an emitter signal in accordance with one or more embodiments described herein.

FIG. 2C illustrates received signal power at multiple frequencies in accordance with one or more embodiments described herein.

FIG. 2D illustrates emitter signal phase at multiple frequencies in accordance with one or more embodiments described herein.

FIG. 2E illustrates received signal phase at multiple frequencies in accordance with one or more embodiments described herein.

FIG. 3A is a perspective view illustrating an example of an imaging LIDAR system in accordance with one or more embodiments described herein.

FIG. 3B is a front view illustrating an example of an imaging LIDAR system in accordance with one or more embodiments described herein.

FIG. 4 is a perspective view illustrating an example of a vehicle-mounted imaging LIDAR system in accordance with one or more embodiments described herein.

FIG. 5 is a general block diagram of the electrical circuit system that implements one or more embodiments described herein.

### DETAILED DESCRIPTION OF THE EMBODIMENTS

The following description presents one or more embodiments of imaging LIDAR useful for making simultaneous distance measurements to multiple points in a scene. The person of ordinary skill in the art will readily recognize that the principles and features described herein may be equally applicable to making distance measurements to one or more points in a scene without regard to simultaneity. Furthermore, one or more embodiments are described in which measurements may be made of a static target or targets using one or more static light sources and a static detector. However, in accordance with the principles of the invention, measurements may be made of dynamic targets and/or by using a dynamic detector to suit intended purposes. In such embodiments, it may be necessary for optical or other components in the system to be dynamic as well, as the person of ordinary skill will readily recognize and implement as appropriate.

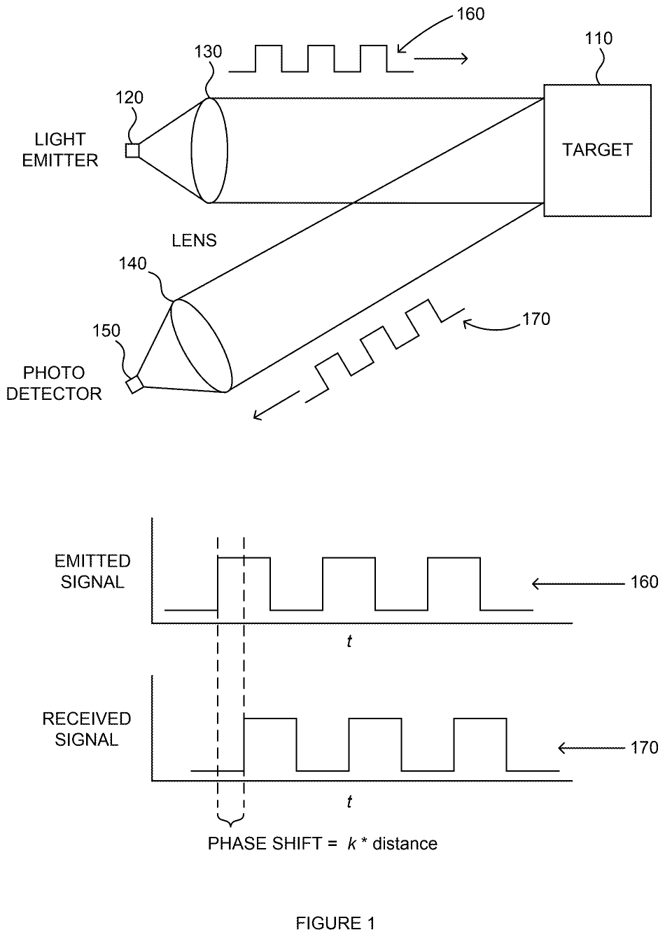

FIG. 1 illustrates an example of calculating a distance to a target 110 in one or more embodiments. In one or more examples, target 110 may be a stationary or static target. In accordance with the example shown, to measure the distance to target 110, a light source or emitter 120 (for example, a light-emitting device such as an LED or laser diode) may be modulated in intensity at a fixed frequency f and the emitted light directed out in a collimated beam through a lens 130. Light having passed through lens 130 that hits a point in the scene (e.g., a point on target 110) is scattered and some of this scattered light may be collected and directed by a lens 140 onto a receiver 150, which may comprise a photodetector. In one or more examples, receiver 150 may be stationary or static. By comparing the phase of the outgoing waveform 160 to that of the received waveform 170, the distance from emitter 120 to target 110 can be determined: e.g., a waveform 160 with a 1 MHz intensity modulation and a 180 degree phase shift implies a target 110 at 75 meters

$$( distance = \frac{c}{4 π f} Δ∅ ) .$$

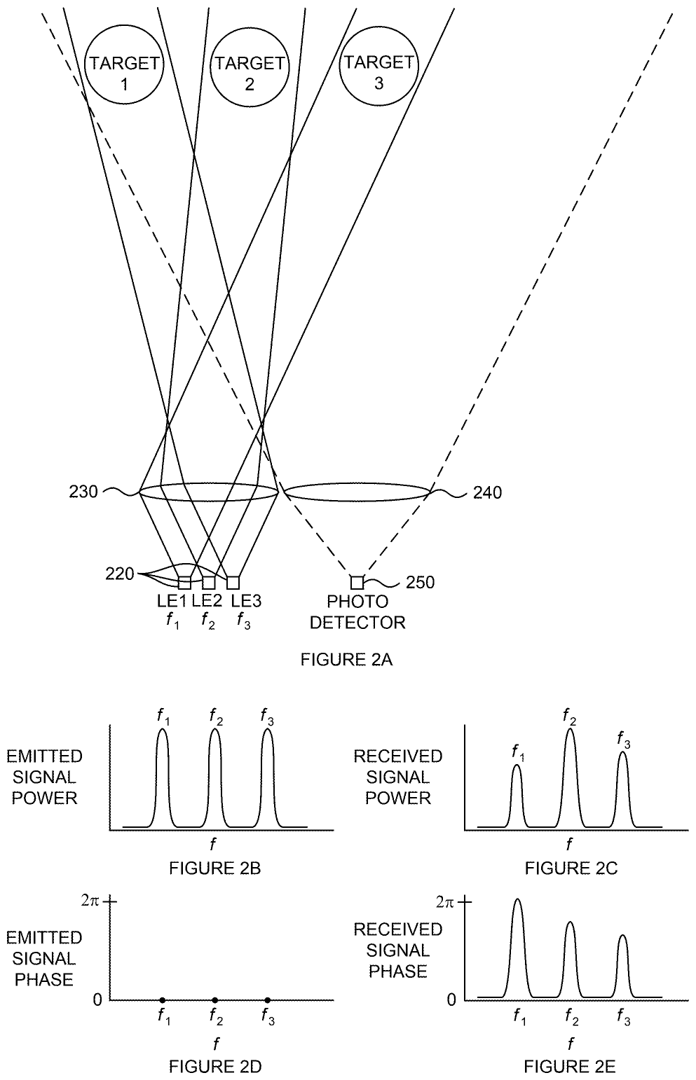

In one or more embodiments, it may be possible to determine multiple distances to multiple targets 110 (or multiple points of a single target or “scene”) simultaneously or substantially simultaneously. An example is described with reference to FIGS. 2A-2E. In one or more such embodiments, as shown in FIG. 2A, multiple emitters 220 may be set behind a transmitter lens 230. In one or more embodiments, emitters 220 may be static and arranged in a predetermined pattern. Transmitter lens 230 may be arranged to collimate the output of each emitter 220 into a different direction. In one or more embodiments, a receiver 250 for the light returned from the target(s) may comprise a single photodetector or multiple photodetectors. In one or more embodiments, receiver 250 may be static. A receiver lens 240 may be arranged to make the receiver field of view wide enough to “see” (receive light corresponding to) all or nearly all transmitted beam angles.

Referring to FIG. 2B, each emitter 220 may be intensity modulated at a respective frequency (e.g., f₁ at MHz, f₂ at 1.1 MHz, f₃ at 1.2 MHz, etc.). An electrical signal output by receiver 250 may be analyzed by Fourier transformation or by a similar method or methods to isolate the signal at each modulation frequency, for example f₁, f₂ and f₃ (FIG. 2C). Further, the phase at each frequency can be measured independently through digital signal processing and the phase shift of each signal determined independently, for example (refer to FIGS. 2D and 2E). Thus, even with a single receiver 250 and multiple transmitter elements 210, multiple targets or points can be ranged simultaneously with lower cost components and reduced custom circuitry. Moreover, if emitter 220 comprises a laser diode array, the cost of the system may be reduced further if, for example, the laser diode array can be generated in a single lithography process as part of a circuit board that drives the lasers, as compared to a system in which each laser is provided independently and affixed to the underlying driving circuitry.

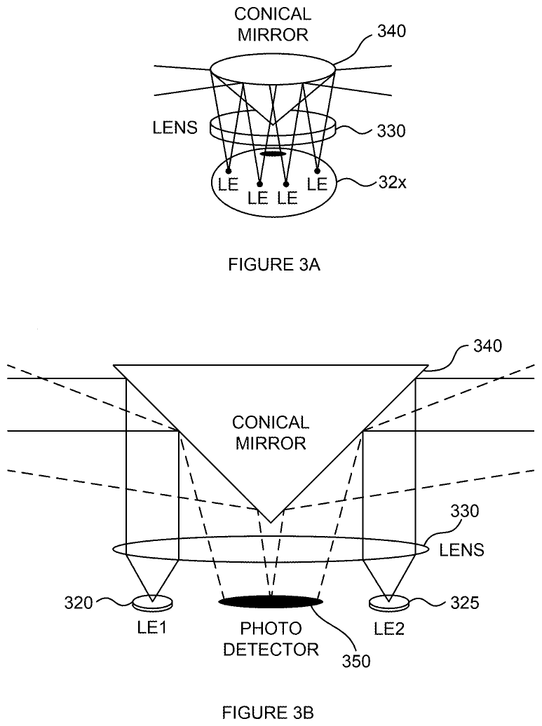

In one or more embodiments, a mirror may be employed to direct emitted light to plural targets or points. An example is described with reference to FIGS. 3A and 3B, in which a plurality of emitters 32X may be arranged to emit light through a lens 330 to a mirror 340, which reflects the light toward targets or points to be ranged. See, e.g., FIG. 3A, in which a conical mirror 340 is shown, although its configuration may be chosen based on the imaging environment, target, cost considerations, etc.

FIG. 3B is a side view of the arrangement shown in FIG. 3A, illustrating two emitters 320, 325 of emitters 32X and enlarged for clarity. Light from emitters 320, 325 is reflected from mirror 340 to corresponding targets (not shown) and the light returning from the targets is reflected by mirror 340 and input to receiver 350. Receiver 350 converts the optical inputs to one or more electrical signal outputs.

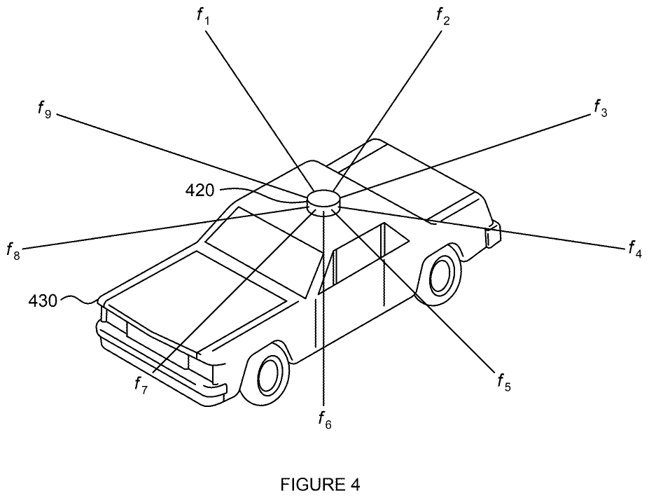

FIG. 4 illustrates an example in which a circular array of light emitters 420 may be directed to and around a vehicle 430 through a set of optics (not shown) in one or more embodiments, and the received signals are all directed back on to a single common detector or receiver (not shown). In one or more embodiments, the emitters, receiver, and optics may include one or more of the components shown in FIGS. 3A and 3B. Moreover, in one or more embodiments, multiple targets (not shown) may be ranged simultaneously. Such targets may include, but are not limited to, one or more of vehicles, walls, guard rails, lane markers, trees, etc.

The intensity modulation approach is advantageous at least in part because lower-cost laser diodes and LED's can be used as emitters. Such emitters may run at higher average powers and modulation frequencies but cannot easily generate the high peak powers generated by some optically pumped and Q-switched lasers for standard time of flight measurements. Additionally, because the range information can be encoded in the relative phase of the waveform, the bandwidth of the receiver electronics can be quite small and only need be as large as the measurement update rate (e.g., a 10 Hz update range only requires a bandwidth of 10 Hz centered around a 1 MHz intensity modulation frequency). In contrast, some time of flight LIDAR's may require bandwidths of 100's of MHz or more to obtain the range resolution required. This smaller bandwidth may reduce measurement noise, allowing target 110 to be measured with, e.g., a lower power laser and putting a higher margin on eye safety, as well as reduces the cost of the instrument as a whole. Modulation frequencies can range from MHz to GHz; an example array of emitters would emit at 1.0 MHz, 1.1 MHz, 1.2 MHz, . . . 5.0 MHz for longer range systems measuring targets of interest on meter-type length scales or 1.0 GHz, 1.1 GHz, 1.2 GHz 5.0 GHz for systems measuring on centimeter length scales. Modulation amplitudes (specifically the amplitude of the received signal) may not be critical provided it is strong enough to be resolved amidst detector noise.

The frequency primarily determines the length scale to which the measurement is sensitive. As an example, for a system running at 100 kHz, it will be sensitive to targets out to multiple kilometers with a resolution on the order of meters. For a system running with a frequency of 1 MHz, it will be sensitive to targets out to hundreds of meters with a resolution on the order of 1/10th meter, and for a system running at GHz frequencies, it will be sensitive to targets out to tens of cm with 1/10th mm resolution. As the frequency goes up so does the resolution. However, the maximum distance to which a measurement can be made with a given frequency goes down. The high frequencies beyond several GHz become difficult to implement because medium power lasers have trouble being modulated any faster than several GHz typically and the lower frequencies below 100 kHz become less useful because the resolution of meters is often too large to be of much use to many end users. However, this may depend on the application; in principle there is no lower bound in frequency provided the application can tolerate a larger resolution. At the high frequency side, applications will be limited to what lasers can be modulated at which in principle will improve as the technology matures.

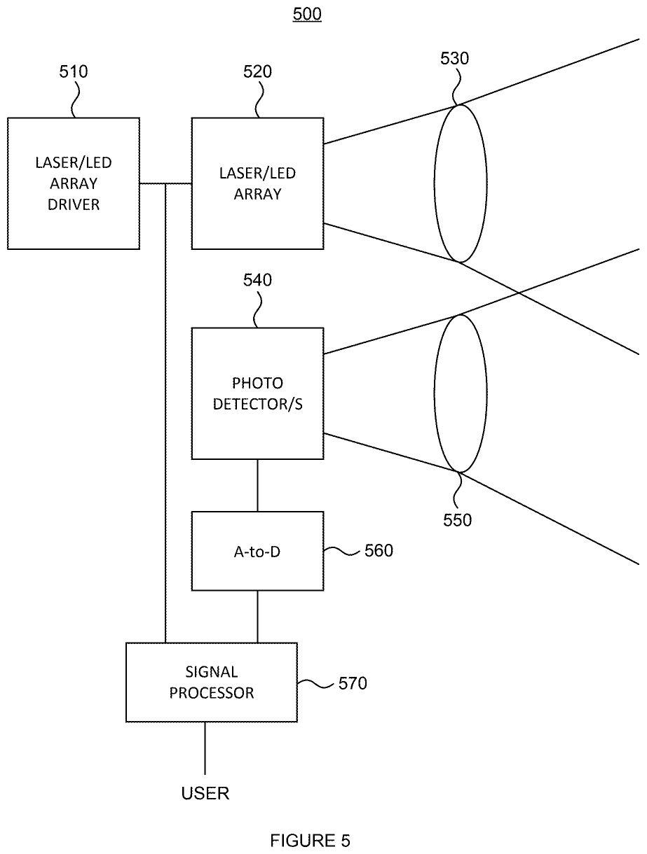

As shown in FIG. 5, one embodiment of the electrical circuit system 500 that may be used to implement one or more embodiments of the invention consists of laser/LED array driver circuit 510 that connects to laser/LED array 520. The laser/LED array is operatively connected to emit light onto the lens 530 to then illuminate one or more targets. The laser/LED array driver circuit 510 is also connected to a signal processor 570 that controls the operation of the driver circuit 510. A user interfaces with the signal processor 570 through a conventional user interface (not shown) as known in the art and will not be discussed further herein.

The signal processor 570 is further connected to an A-to-D converter circuit 560 that is connected to receive input signals from a photodetector 540. The photodetector 540 is operatively positioned to receive scattered light from the one or more targets through a lens 550. As in the operation described hereinabove with respect to FIG. 1, to measure the distance to one or more targets, the laser/LED array 520 is modulated in intensity at a fixed frequency f and the emitted light directed out in a collimated beam through the lens 530. Light having passed through lens 530 that hits a point on the target(s) such that the light is scattered, some of which may be collected and directed by the lens 550 onto the photodetector 540.

Although embodiments have been described in which a static system detects the distance to a static target or targets and in which a moving system detects the distance to a static target or targets, the principles described herein can be applied to a static or moving system that detects the distance and/or speed of a moving target or targets using any of a number of mathematical techniques that will become readily apparent to one of ordinary skill. Similarly, the principles described herein can be applied to a system having at least one static system and at least one moving system detecting the distance and/or speed of at least one moving target and/or at least one stationary target using any of a number of mathematical techniques that will become readily apparent to one of ordinary skill in the art. The advantageous features described above, as well as other advantages, are merely illustrative and the disclosed embodiments may enjoy one or more of the advantages described herein as well as other advantages.

As used herein, a “target” can be anything to which the distance is to be determined. For example, a target can be an unnamed point, a location, a physical object, etc. In addition, a target can be specifically chosen or can become the target when its motion is detected, for example when the system is used in conjunction with a motion detector.

As further used herein, “light” can be any electromagnetic wave suitable for distance measuring, and is not limited to the visible spectrum.

Various changes and modifications to the disclosed imaging LIDAR system will be apparent to those skilled in the art. All such changes and modifications that rely on the basic teachings and principles through which the invention has advanced the state of the art are to be understood as included within the spirit scope of the present invention.

1. A system for determining the distance to multiple points in a scene, comprising:
a plurality of emitters arranged to emit electromagnetic waves toward a scene substantially simultaneously;
a receiver arranged to receive the electromagnetic waves after being scattered from multiple points in the scene, and to output a signal corresponding to each received electromagnetic wave; and
computing electronics configured to:
compare a phase of the emitted electromagnetic waves with a phase of each corresponding received electromagnetic wave in the output signal; and
determine a distance to each of the multiple points based on the comparison of the phases.

2. The system of claim 1, further comprising:
a transmitter lens arranged to collimate the emitted electromagnetic waves; and
a receiver lens arranged to collimate the scattered electromagnetic waves.

3. The system of claim 1, further comprising:
a controller configured to intensity modulate each of the plurality of emitters at a different respective frequency;
wherein the computing electronics are further configured to isolate the output signal at each respective frequency to permit identification of the emitter corresponding to each of the isolated frequencies.

4. A method for measuring multiple distances with a plurality of emitters and a single photodetector, comprising:
emitting electromagnetic waves toward a scene substantially simultaneously;
receiving the electromagnetic waves after being scattered from multiple points in the scene;
outputting a signal corresponding to each received electromagnetic wave;
comparing a phase of the emitted electromagnetic waves with a phase of each corresponding received electromagnetic wave in the output signal; and
determining a distance to each of the multiple points based on the comparison of the phases.

5. The method of claim 4, further comprising:
intensity modulating each of the plurality of emitters at a different respective frequency; and
isolating the output signal at each respective frequency to permit identification of the emitter corresponding to each of the isolated frequencies.
